(19) United States
(12) Patent Application Publication
(10) Pub. No.: US 2026/0243537 A1
(43) Pub. Date: Aug. 20, 2026

(54) DEVICES FOR LEVELING SCOPE RETICLES OF CROSSBOWS

(71) Applicant: John T. Buck, Wantagh, NY (US)

(72) Inventor: John T. Buck, Wantagh, NY (US)

(21) Appl. No.: 19/438,316

(22) Filed: Dec. 31, 2025

Related U.S. Application Data
(60) Provisional application No. 63/759,049, filed on Feb. 15, 2025.
(60) Provisional application No. 63/768,951, filed on Mar. 8, 2025.

(51) Int. Cl. F41B 5/14; F41B 5/12; G01C 9/28

(52) U.S. Cl. CPC F41B 5/1484; F41B 5/12; G01C 9/28

(57) ABSTRACT

A level device includes a baseplate having an upper surface and a bottom surface, and a bubble level coupled to the upper surface of the baseplate. The baseplate includes a groove formed in the upper surface, and a tongue structure disposed on the bottom surface. The level device is structurally configured for mounting on an upper surface of a crossbow barrel of a crossbow, with the bottom surface of the baseplate in contact with the upper surface of the crossbow barrel and the tongue structure disposed within a flight groove of the crossbow barrel, and a portion of a bowstring of the crossbow disposed within the groove in the upper surface of the baseplate to secure the level device on the upper surface of the crossbow barrel.

### CROSS-REFERENCE TO RELATED APPLICATIONS

This application claims the benefit of U.S. Provisional Application Ser. No. 63/759,049, filed on Feb. 15, 2025, and U.S. Provisional Application Ser. No. 63/768,951, filed on Mar. 8, 2025, the disclosures of which are fully incorporated herein by reference.

### BACKGROUND

This disclosure relates generally to devices and techniques for bore sighting of crossbow scopes and, in particular, to devices and techniques for leveling scope reticles of crossbow scopes. In the hunting industry, crossbows are popular weapons that are used for hunting game animals. An important component of a crossbow is a crossbow scope which is utilized for aiming at targets. A crossbow scope must be properly installed on a crossbow through a process referred to as “bore sighting” to ensure accuracy and consistency when aiming and shooting at targets. In general, bore sighting is a process which involves, for example, aligning a scope reticle (e.g., crosshairs) of the crossbow scope with a bore (center of a crossbow barrel) of the crossbow. A common issue that arises when a crossbow scope is not properly aligned with the bore of a crossbow is a “canting” of the scope reticle, where the scope reticle is tilted (or slightly rotated) with respect to the crossbow barrel. The canting of the scope reticle can result in misalignment and inaccurate aiming and shooting at a target.

### SUMMARY

Exemplary embodiments of the disclosure include devices and techniques for bore sighting crossbow scopes and, in particular, to devices and techniques for leveling scope reticles of crossbow scopes.

For example, an exemplary embodiment includes a level device which comprise a baseplate having an upper surface and a bottom surface, and a bubble level coupled to the upper surface of the baseplate. The baseplate includes a groove formed in the upper surface, and a tongue structure disposed on the bottom surface. The level device is structurally configured for mounting on an upper surface of a crossbow barrel of a crossbow, with the bottom surface of the baseplate in contact with the upper surface of the crossbow barrel and the tongue structure disposed within a flight groove of the crossbow barrel, and a portion of a bowstring of the crossbow disposed within the groove in the upper surface of the baseplate to secure the level device on the upper surface of the crossbow barrel.

Another exemplary embodiment includes a level device which comprises a housing element configured to house a bubble level, a first retaining wall and a second retaining wall, and an elongated alignment element. The first and second retaining walls extend from a planar bottom surface of the housing element, and are spaced apart by a given distance. The elongated alignment element extends from the housing element. The level device is structurally configured for mounting on an upper scope adjustment dial of a crossbow scope, with the planar bottom surface of the housing element in contact with a top surface of the upper scope adjustment dial, and the upper scope adjustment dial disposed between the first and second retaining walls.

Another exemplary embodiment includes a leveling kit for bore sighting a crossbow scope. The leveling kit comprises a first level device and a second level device. The first level device is structurally configured for mounting on an upper surface of a crossbow barrel of a crossbow. The first level device is configured for use in horizontally leveling a lateral axis of the crossbow barrel, when the first level device is mounted on the upper surface of the crossbow barrel. The second level device is structurally configured for mounting on an upper scope adjustment dial of a crossbow scope. The second level device is configured for use in aligning a scope reticle of the crossbow scope in a non-canted orientation with respect to the lateral axis and a vertical axis of the crossbow barrel, when the second level device is mounted on the upper scope adjustment dial of the crossbow scope, and when the lateral axis of the crossbow barrel is horizontally leveled by use of the first level device mounted on the upper surface of the crossbow barrel.

Other embodiments will be described in the following detailed description of exemplary embodiments, which is to be read in conjunction with the accompanying figures.

### BRIEF DESCRIPTION OF THE DRAWINGS

FIGS. 1A and 1B schematically illustrate a crossbow having a crossbow scope which can be bore sighted using leveling devices and methods according to exemplary embodiments of the disclosure.

FIG. 1C is a perspective view of a crossbow scope which can be bore sighted using leveling devices and methods according to exemplary embodiments of the disclosure.

FIG. 1D schematically illustrates a scope reticle in different orientations including a non-canted orientation and canted (tilted) orientations.

FIGS. 2A, 2B, 2C, 2D, and 2E illustrate a leveling system comprising a first level device and a second level device, which are configured for use in bore sighting a crossbow scope, according to an exemplary embodiment of the disclosure.

FIGS. 3A, 3B, 3C, and 3D schematically illustrate a method for utilizing a leveling system comprising first and second level devices to bore sight a crossbow scope, according to exemplary embodiments of the disclosure.

FIG. 4 is a schematic perspective view of a level device which is configured for use in bore sighting a crossbow scope, according to another exemplary embodiment of the disclosure.

FIG. 5 is a schematic perspective view of a level device which is configured for use in bore sighting a crossbow scope, according to another exemplary embodiment of the disclosure.

FIG. 6 is a schematic perspective view of a level device which is configured for use in bore sighting a crossbow scope, according to another exemplary embodiment of the disclosure.

FIG. 7 is a schematic perspective view of a level device which is configured for use in bore sighting a crossbow scope, according to another exemplary embodiment of the disclosure.

FIG. 8A is a flow diagram of a method for bore sighting a crossbow scope using a leveling system comprising first and second level devices, according to exemplary embodiment of the disclosure.

FIG. 8B schematically illustrates a step for establishing proper eye relief as part of the bore sighting method of FIG. 8A, according to an exemplary embodiment of the disclosure.

### DETAILED DESCRIPTION OF EXEMPLARY EMBODIMENTS

Exemplary embodiments of the disclosure will now be described in further detail with regard to crossbow scope leveling devices and techniques for leveling scope reticles of crossbow scopes. The exemplary crossbow scope leveling devices and techniques as described herein allow an individual to properly align a scope reticle (e.g., crosshairs) of a crossbow scope with a crossbow barrel of the crossbow and ensure that the scope reticle is properly aligned in a non-canted (e.g., not tilted) orientation with respect to the crossbow barrel. For example, the exemplary crossbow scope leveling devices and techniques enable a vertical alignment line of a scope reticle to be aligned in a direction that is orthogonal (perpendicular) to an upper surface (or flight rail surface) of a crossbow barrel.

For example, an exemplary embodiment includes a level device which comprise a baseplate having an upper surface and a bottom surface, and a bubble level coupled to the upper surface of the baseplate. The baseplate includes a groove formed in the upper surface, and a tongue structure disposed on the bottom surface. The level device is structurally configured for mounting on an upper surface of a crossbow barrel of a crossbow, with the bottom surface of the baseplate in contact with the upper surface of the crossbow barrel and the tongue structure disposed within a flight groove of the crossbow barrel, and a portion of a bowstring of the crossbow disposed within the groove in the upper surface of the baseplate to secure the level device on the upper surface of the crossbow barrel.

Another exemplary embodiment includes a level device which comprises a housing element configured to house a bubble level, a first retaining wall and a second retaining wall, and an elongated alignment element. The first and second retaining walls extend from a planar bottom surface of the housing element, and are spaced apart by a given distance. The elongated alignment element extends from the housing element. The level device is structurally configured for mounting on an upper scope adjustment dial of a crossbow scope, with the planar bottom surface of the housing element in contact with a top surface of the upper scope adjustment dial, and the upper scope adjustment dial disposed between the first and second retaining walls.

Another exemplary embodiment includes a leveling kit for bore sighting a crossbow scope. The leveling kit comprises a first level device and a second level device. The first level device is structurally configured for mounting on an upper surface of a crossbow barrel of a crossbow. The first level device is configured for use in horizontally leveling a lateral axis of the crossbow barrel, when the first level device is mounted on the upper surface of the crossbow barrel. The second level device is structurally configured for mounting on an upper scope adjustment dial of a crossbow scope. The second level device is configured for use in aligning a scope reticle of the crossbow scope in a non-canted orientation with respect to the lateral axis and a vertical axis of the crossbow barrel, when the second level device is mounted on the upper scope adjustment dial of the crossbow scope, and when the lateral axis of the crossbow barrel is horizontally leveled by use of the first level device mounted on the upper surface of the crossbow barrel.

In another exemplary embodiment, which may be combined with one or more of the embodiments of the preceding paragraphs, the first level device of the leveling kit comprises a baseplate having an upper surface and a bottom surface, and a bubble level coupled to the upper surface of the baseplate. The baseplate comprises a groove formed in the upper surface, and a tongue structure disposed on the bottom surface. The first level device is structurally configured for mounting on the upper surface of the crossbow barrel with the bottom surface of the baseplate in contact with the upper surface of the crossbow barrel and the tongue structure disposed within a flight groove of the crossbow barrel, and a portion of a bowstring of the crossbow disposed within the groove in the upper surface of the baseplate to secure the first level device on the upper surface of the crossbow barrel.

In another exemplary embodiment, which may be combined with one or more of the embodiments of the preceding paragraphs, the bubble level of the first level device comprises a tubular bubble level which is disposed in alignment with the lateral axis of the crossbow barrel, when the first level device is mounted on the upper surface of the crossbow barrel.

In another exemplary embodiment, which may be combined with one or more of the embodiments of the preceding paragraphs, the second level device of the leveling kit comprises a housing element configured to house a bubble level, a first retaining wall and a second retaining wall, and an elongated alignment element. The first and second retaining walls extend from a planar bottom surface of the housing element, and are spaced apart by a given distance. The elongated alignment element extends from the housing element. The second level device is structurally configured for mounting on the upper scope adjustment dial of a crossbow scope, with the planar bottom surface of the housing element in contact with a top surface of the upper scope adjustment dial, and the upper scope adjustment dial disposed between the first and second retaining walls.

In another exemplary embodiment, which may be combined with one or more of the embodiments of the preceding paragraphs, the bubble level of the second level device comprises a tubular bubble level.

In another exemplary embodiment, which may be combined with one or more of the embodiments of the preceding paragraphs, a longitudinal axis of the elongated alignment element is disposed orthogonal to a longitudinal axis of the tubular bubble level of the second level device.

It is to be understood that various features shown in the accompanying drawings are schematic illustrations which may not be drawn to scale. Moreover, the same or similar reference numbers are used throughout the drawings to denote the same or similar features, elements, or structures, and thus, a detailed explanation of the same or similar features, elements, or structures will not be repeated for each of the drawings. Further, the term “exemplary” as used herein means “serving as an example, instance, or illustration.” Any embodiment or design described herein as “exemplary” is not to be construed as preferred or advantageous over other embodiments or designs.

To provide spatial context to the different structural orientations of devices and structures shown throughout the drawings, XYZ Cartesian coordinates are shown in some of the drawings as a three-axis (X-Y-Z) coordinate system including an X-axis, a Y-axis, and a Z-axis, which are all orthogonal in relation to each other. The X-axis and Y-axis extend orthogonal to each other in a 2D plane, and the Z-axis extends in a direction which is orthogonal to the 2D plane defined by the X-axis and Y-axis. It is to be noted that the terms “vertical” or “vertical direction” as used herein denote a Z-direction of the Cartesian coordinates shown in the drawings, and the terms “horizontal,” or “horizontal direction,” or “lateral direction” as used herein denote an X-direction and/or a Y-direction of the Cartesian coordinates shown in the drawings.

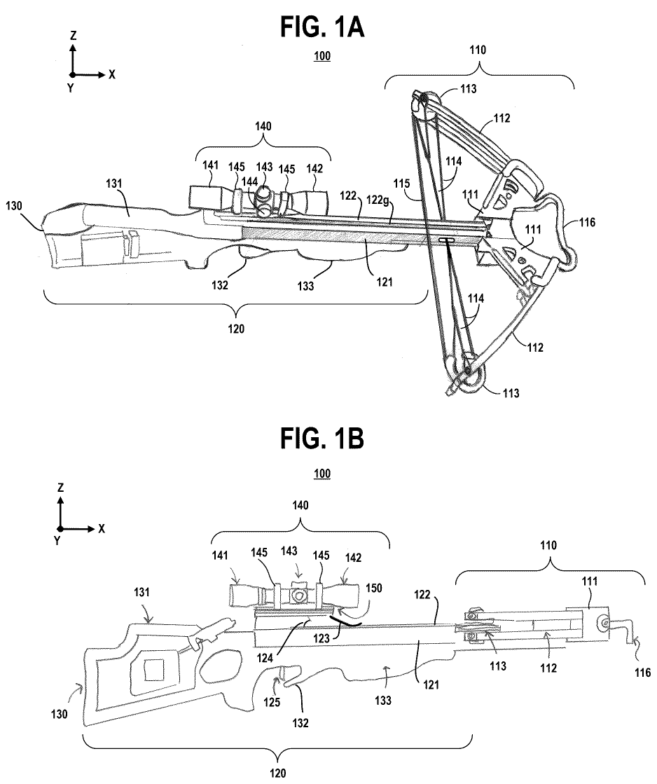

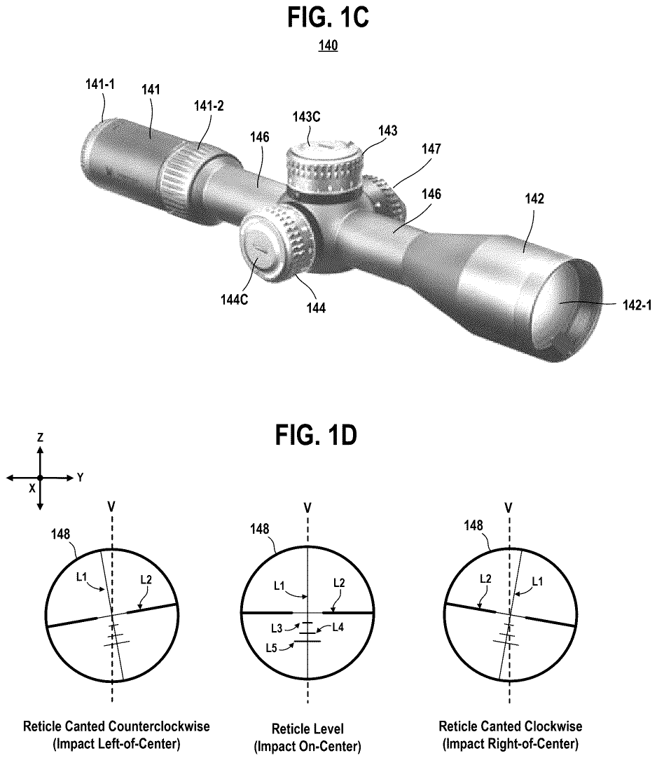

FIGS. 1A and 1B schematically illustrate a crossbow 100 having a crossbow scope which can be mounted using leveling devices and methods according to exemplary embodiments of the disclosure. In addition, FIG. 1C is a perspective view of a crossbow scope which can be mounted to the crossbow 100 using leveling devices and methods according to exemplary embodiments of the disclosure. In particular, FIG. 1A is a schematic perspective view of the crossbow 100 and FIG. 1B is a schematic side view of the crossbow 100. In general, the crossbow 100 comprises a front-end bow assembly 110, a main beam 120, and a crossbow scope 140. The crossbow scope 140 is mounted on the main beam 120 via a sight bridge device 150 (or crossbow scope mount rail 150). The crossbow 100 comprises a compound bow architecture in which the front-end bow assembly 110 comprises various components including, e.g., risers 111, limbs 112, cams/pulleys 113, cables 114, a bowstring 115, and a cocking stirrup 116. The main beam 120 include various components including, e.g., a crossbow barrel 121, a flight rail 122, a flight groove 122g, a bolt retention spring 123, a latch 124 (or latch trigger), a trigger 125, a butt stock 130, a check rest 131, a trigger guard 132, and a foregrip 133. Essentially, the flight rail 122 comprises a planar (flat) upper surface of the crossbow barrel 121, and the flight groove 122g comprises a grooved track that longitudinally extends along the center region of the flight rail 122 (top surface of the crossbow barrel 121) between the front-end bow assembly 110 and the latch 124. In some embodiments, the flight groove 122g has a V-shaped profile.

The crossbow 100 is designed to shoot a dart-like projectile that is referred to as a “bolt.” A bolt is similar to an arrow, but a bolt is typically shorter and heaver that an arrow, and comprises an oblong head and four fletchings (or flight vanes) for flight stability. As explained in further detail below, when a bolt is placed onto the flight rail 122 of the crossbow barrel 121 with the crossbow 100 in a cocked position, one of the flight vanes is inserted into the flight groove 122g. In this manner, when the bolt is launched, the flight groove 122g guides the bolt along the flight rail 122 of the crossbow barrel 121 by virtue of, e.g., the flight vane inserted into the flight groove 122g.

In the front-end bow assembly 110, the risers 111 include limb pockets which are configured to attach to the limbs 112 and hold the limbs 112 at a certain angle. The limbs 112 can have split designs (as schematically illustrated in FIGS. 1A and 1B) or solid designs. The limbs 112 are configured to have the cams/pulleys 113 rotatably mounted on ends thereof. The cams/pulleys 113 are configured to receive the cables 114 and bowstring 115. The cables 114 are connected to the cams/pulleys 113 as well as the bowstring 115. The bowstring 115 is attached to the cams/pulleys 113 and when the bowstring 115 is pulled back, the cams/pulleys 113 turn, which causes the limbs 112 to bend and store a large amount of kinetic energy, which is then released once the trigger 125 is pulled. The cams/pulleys 113 can be round or oval shaped, wherein the shape dictates the draw force curve of the crossbow 100, and how much energy is transferred and stored when the bowstring 115 is pulled back. The term “power stroke” refers to a linear distance that the bowstring 115 is moved between an un-cocked position to a cocked position. The limbs 112 of the crossbow 100 are much heavier (stiffer) than on a standard vertical bow because the power stroke in a crossbow can be more than half as short as the stroke of a typical vertical bow. The cables 114 work in tandem with the cams/pulleys 113 for the purpose of reinforcing the crossbow 100 and adjusting its firing power. In some crossbow designs, as schematically illustrated in FIG. 1A, the cables 114 extend through an opening in the crossbow barrel 121 below the flight rail 122, while the bowstring 115 is disposed above the flight rail 122. The cams/pulleys 113 serve to keep the cables 114 taut as the bowstring 115 is pulled back.

The bowstring 115 is the component which is used to propel a bolt forward. The bowstring 115 will influence the firing power and performance of the crossbow 100. The bowstring 115 is light and durable in order to effectively transfer maximum energy from the bow to the bolt (e.g., made of polyester fiber, synthetic fiber, and natural fiber). The material is chosen based on breaking strength, weight, and stretch capability. A “serving” is wound tightly around the bowstring 115 to protect the bowstring 115 from the arrow retention spring 123 which holds it in the cocked position. The serving is typically four inches long, and contacts and rides across the flight rail 122 once the trigger 125 is activated and the bolt of the crossbow 100 is fired at its intended target.

The butt stock 130 is the portion of the main beam 120 which is configured to rest against the shoulder of an individual when shooting a bolt at a target. The butt stock 130 serves as a functional base of the crossbow 100, which ties the crossbow barrel 121, the trigger 125, and the sight bridge 150 together. The foregrip 133 is used to hold and manipulate the crossbow 100 by the individual's aiming hand. The foregrip 133 helps steady the individual's aim and keep the crossbow 100 aligned to the target. Some crossbow designs include removable foregrips or collapsible foregrips.

The latch 124 is a mechanism that is designed to capture the bowstring 115 when the crossbow 100 is placed into a cocked position. The latch 124 operates by holding the bowstring 115 in place (in a cocked position) and keeps the bowstring 115 taut until it is released by pressing the trigger 125. The bolt retention spring 123 is a metal or plastic bar designed to hold the bolt in the flight groove 122g until the trigger 125 releases the latch 124. The bolt retention spring 123 keeps the bolt from slipping out of place while the crossbow 100 is manipulated in a cocked position before shooting the bolt. The trigger 125 is the mechanism which is used to release the bowstring 115 and shoot the bolt. A safety mechanism prevents accidental release of a bolt, where the safety mechanism may engage manually or automatically once the crossbow 100 is cocked.

The crossbow 100 is used by an individual to shoot a bolt as follows. As a first step, the individual must place the crossbow 100 in a cocked position using, e.g., the cocking stirrup 116. The cocking stirrup 116 is a hoop-shaped metal foothold that is utilized to assist in cocking the crossbow 100. The individual places his/her foot into the cocking stirrup 116, and then grasps the bowstring 115 on both sides of the crossbow barrel 121 and pulls the bowstring 115 back until the bowstring 115 engages the latch 124 to lock the bowstring 115 in a cocked position. A rope cocking device with hooks and handles can be used to pull back the bowstring 115. Some crossbows are equipped with a built-in or attachable crank cocking device, which comprises a crank handle that is turned until the bowstring is pulled back and locked into the latch 124.

With the crossbow 100 in the cocked position, the individual will place a bolt on the flight rail 122 by inserting one flight vane (e.g., odd-colored vane) within the flight groove 122g, and inserting the bowstring 115 in a nock of the bolt. The flight rail 122 and flight groove 122g are configured to allow the bolt to lie in alignment with the bowstring 115. In this manner, when the bolt is launched, the flight groove 122g guides the bolt along the flight rail 122 of the crossbow barrel 121 by virtue of the one flight vane that is disposed within the flight groove 122g, while other flight vanes glide along flight rail 122 of the crossbow barrel 121 without interference until the bolt is launched from the crossbow 100.

The crossbow scope 140 is utilized to aim and align the bolt at an intended target. As schematically illustrated in FIGS. 1A, 1B, and 1C, the crossbow scope 140 comprises an eyepiece 141, an objective bell 142, crossbow scope adjustment dials (or turrets), which include an elevation turret 143 (or upper scope adjustment dial), a windage turret 144, and an optional parallax adjustment turret 147, scope rings 145, and a scope body 146. The eyepiece 141 comprises an ocular lens 141-1, and a power ring 141-2 (for zoom and magnification). The objective bell 142 comprises an objective lens 142-1. The scope body 146 comprises a metal tube that holds and connects the ocular lens 141-1 and the larger objective lens 142-1. The scope rings 145 are designed to fixedly secure the scope body 146 (and thus the crossbow scope 140) to the sight bridge device 150. The sight bridge device 150 (or scope mount rail 150) includes a scope rail which mechanically interfaces with the scope rings 145 to mount the crossbow scope 140 to the sight bridge device 150. The sight bridge device 150 can implement one of various types of commercially available scope rails including, e.g., a Weaver rail, dovetail rail, a Picatinny rail, etc., which are matched with the mechanical mating interfaces of the scope rings 145.

In general, crossbow scope adjustment turrets (or scope adjustment dials) are configured to enable aiming adjustments at targets to compensate for, e.g. windage, elevation, and optionally parallax. In particular, the elevation turret 143 comprises an adjustment knob which can be turned to make vertical (up and down) adjustments of a scope reticle to adjust for the dropping of a bolt while in flight over distance due to gravity. The windage turret 144 comprises an adjustment knob which can be turned to make horizontal (left and right) adjustments of the scope reticle to compensate for an anticipated lateral displacement of a bolt in flight over distance due to wind. The elevation turret 143 and the windage turret 144 as shown in FIG. 1C are “capped” turrets which comprise respective caps 143C and 144C that are configured and used to “lock” the adjustment turrets in place to prevent inadvertent adjustments during transport of the crossbow 100.

The crossbow scope 140 optics comprise a “reticle” (or scope reticle) that is utilized to enhance shooting accuracy. In general, a reticle of a crossbow scope comprises markings that are viewable when looking through the crossbow scope, wherein the markings provide aiming points to aim and align a bolt at an intended target. For example, reticles typically include some type of “crosshairs” design which includes intersecting vertical and horizontal lines. In addition, some scope reticles are designed to include additional reticle markings which correspond to different shooting distances, thereby allowing for more precise aiming at varying ranges. There are various types of scope reticle designs including, e.g., single dot scopes, triple dot scopes, multi-reticle scopes, single reticle scopes, etc.

For example, FIG. 1D illustrates an exemplary embodiment of a scope reticle 148 which is a multi-reticle scope that comprises multiple crosshairs or reticles, each calibrated for different distances. In particular, the scope reticle 148 comprises a vertical line L1, and a horizontal line L2 which are orthogonal and provide a crosshair for aiming at a target at a baseline distance (e.g., 20 yards). The scope reticle 148 includes additional horizontal lines L3, L4, and L5 which in conjunction with the vertical line L1, provide additional crosshairs for aiming at targets at different distances (e.g., 30, 40, and 50 yards) that are further than the baseline distance. For example, the vertical L1 and horizontal L3 lines provide crosshairs for aiming at a target distance of 30 yards, the vertical L1 and horizontal L4 lines provide crosshairs for aiming at a target distance of 40 yards, and the vertical L1 and horizontal L5 lines provide crosshairs for aiming at a target distance of 50 yards. When the crossbow scope 140 is tuned to a “zero point” using known techniques, the crosshairs of the scope reticle 148 will correspond to a consistent bolt impact point at a certain distance (e.g., baseline distance corresponding to the crosshairs provided by the vertical L1 and horizontal L2 lines).

As noted above, a crossbow scope must be properly installed on a crossbow through a process referred to as “bore sighting” to ensure accuracy and consistency when aiming and shooting at targets. In general, bore sighting is a process which involves, for example, aligning the scope reticle 148 (e.g., crosshairs) of the crossbow scope with a bore (center of a crossbow barrel) of the crossbow. The term “crossbow bore” is used sometimes to refer to the flight groove 122g where bolt is fired from, while the term “crossbow barrel” is used sometimes to refer to the flat track (or flight rail 122) on the upper surface of the crossbow barrel 121 (e.g., the bore is where the bolt is loaded and shot, whereas the crossbow barrel is designed to keep the bolt stable and aligned for a straight shot). In this regard, the term “crossbow barrel” is synonymous and used interchangeably with the term flight rail (e.g., flight rial 122). In the context of the exemplary bore sighting techniques (e.g., scope reticle leveling techniques) discussed herein, and based on the Cartesian coordinate systems shown in the drawings, it is assumed that the upper surface (flight rail 122) of the crossbow barrel 121 defines a two-dimensional (2D) X-Y plane that is defined by the intersection an X-axis and a Y-axis (which are orthogonal), where the X-axis corresponds to a “longitudinal axis” of the crossbow barrel 121 (in the shooting direction), and where the Y-axis corresponds to a “lateral axis” of the crossbow barrel 121. In addition, it is assumed that the Z-axis corresponds to a “vertical axis” of the crossbow barrel 121 which is perpendicular (normal) to the upper surface (2D X-Y plane) of the crossbow barrel 121.

To be clear, the term “longitudinal axis” of the crossbow barrel 121 corresponds to the axis that runs lengthwise (in the shooting direction of the crossbow) along (or parallel to) the upper planar surface of the crossbow barrel 121 (or the flight groove 122g), and the term “lateral axis” of the crossbow barrel 121 corresponds to the axis that runs across (or parallel to) the upper planar surface of the crossbow barrel 121 orthogonal to the “longitudinal axis” of crossbow barrel 121. In addition, the term “vertical axis” of the crossbow barrel 121 corresponds to the axis that is orthogonal (or normal) to the upper planar surface (flight rail 122) of the crossbow barrel 121.

When aiming and shooting at a target at a certain distance (e.g. in the longitudinal X-axis direction), it is important for the vertical line L1 of the reticle crosshairs to be aligned in a vertically level orientation V (as depicted in FIG. 1D by the scope reticle 148 in the middle), to ensure that the bolt impact will be “on center” and in alignment with the reticle crosshairs. On the other hand, when aiming and shooting at a target with the vertical line L1 of the reticle crosshairs canted counterclockwise with respect to the vertically level orientation V (as depicted in FIG. 1D by the scope reticle 148 on the left), the 2D plane defined by the upper surface (flight rail 122) of the crossbow barrel 121 may be slightly rotated (tilted) counterclockwise (where the lateral axis (Y-axis) of the crossbow barrel 121 is unlevel), resulting in a bolt impact that is “left-of-center” in misalignment with the reticle crosshairs. Similarly, when aiming and shooting at a target with the vertical line L1 of the crosshairs canted clockwise with respect to the vertically level orientation V (as depicted in FIG. 1D by the scope reticle 148 on the right), the 2D plane of the crossbow barrel 121 may be slightly rotated (tilted) clockwise (where the lateral axis (Y-axis) of the crossbow barrel 121 is unlevel), resulting in a bolt impact that is “right-of-center” in misalignment with the reticle crosshairs.

The above description assumes that the crossbow scope 140 is properly mounted on the crossbow 100 (e.g., properly bore sighted to the crossbow barrel 121) such that (i) the horizontal lines of the scope reticle 148 (e.g., horizontal line L2) are aligned in a parallel orientation with the lateral axis (Y-axis) of the crossbow barrel 121, and that (ii) the vertical line L1 of the scope reticle 148 is aligned in Z-direction which is orthogonal (normal) to the 2D plane defined by the upper surface (flight rail 122) of the crossbow barrel 121. In this case, when viewing scope reticle 148 with the vertical line L1 of the crosshairs aligned in the vertically level orientation V (as depicted in FIG. 1D by the scope reticle 148 in the middle), the crossbow 100 will be in a non-canted horizontal orientation where the lateral axis (Y-axis) of the crossbow barrel 121 is horizontally level in the Y-axis direction shown in FIG. 1D.

On the other hand, there can be circumstances where the crossbow scope 140 is improperly mounted on the crossbow 100 where, for example, the scope reticle 148 is slightly canted (either clockwise or counterclockwise) with respect to the vertical and lateral axes of the crossbow barrel 121. In this case, the vertical and horizonal lines of the scope reticle 148 will have an angular deviation from vertical axis (Z-axis) and the lateral axis (Y-axis) of the crossbow barrel 121. In particular, when the crossbow scope 140 is mounted in a canted orientation, (i) the horizontal lines of the scope reticle 148 (e.g., horizontal line L2) are not aligned in a parallel with the lateral axis (Y-axis) of the crossbow barrel 121, and (ii) the vertical line L1 of the scope reticle 148 is not aligned with the vertical axis (Z-axis) of the crossbow barrel 121 (not aligned orthogonal (normal) to the upper surface (flight rail 122) of the crossbow barrel 121). In cases where the crossbow scope 140 is mounted with the scope reticle 148 in a canted orientation with respect to vertical and lateral axes of the crossbow barrel 121, even when properly viewing the scope reticle 148 with the vertical line L1 of the crosshairs aligned in the vertically level orientation V (as depicted in FIG. 1D by the scope reticle 148 in the middle), the crossbow 100 will actually be in canted (unlevel) horizontal orientation where the horizontal lateral axis of the crossbow barrel 121 is tilted left or tilted right (or rolled left or rolled right), resulting in a left-of-center impact or a right-of-center impact, thereby decreasing the aiming and shooting accuracy.

In this regard, to optimize the aiming accuracy of the crossbow scope 140, it is important to mount the crossbow scope 140 with the scope reticle 148 in a non-canted orientation with respect to vertical and lateral axes of the crossbow barrel 121. The exemplary crossbow scope leveling devices and techniques described herein allow an individual to properly mount a crossbow scope to a crossbow with the scope reticle in a non-canted orientation with respect to the vertical and lateral axes of the crossbow barrel 121.

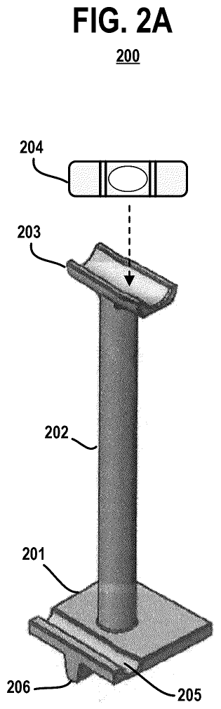

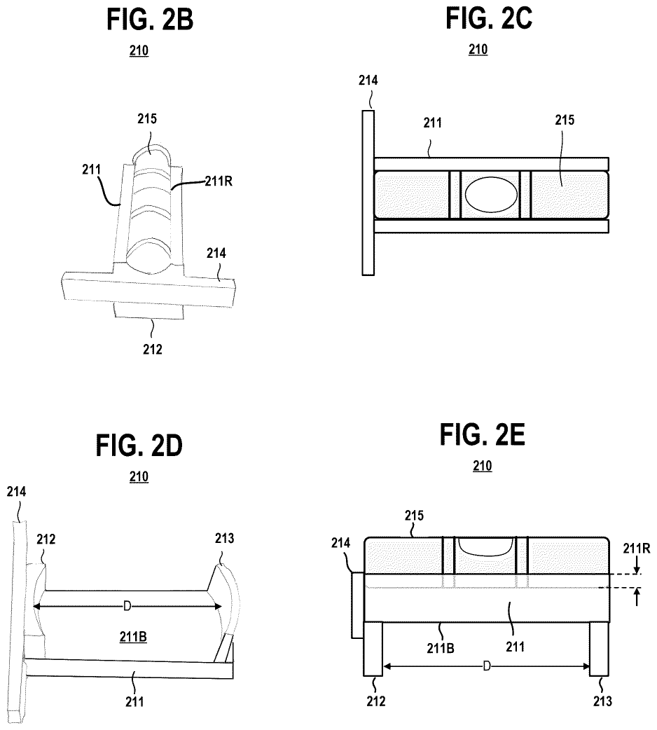

FIGS. 2A, 2B, 2C, 2D, and 2E illustrate a leveling system (e.g., leveling kit) comprising a first level device and a second level device, which are configured for use in bore sighting a crossbow scope, according to an exemplary embodiment of the disclosure. In particular, the scope leveling system (e.g., leveling kit) comprises a first level device 200 (FIG. 2A) and a second level device (FIGS. 2B-2E) which are configured for use in bore sighting a crossbow scope (e.g., bore sighting the crossbow scope 140 of the crossbow 100). The first level device 200 (or primary leveling device) is utilized to horizontally level a crossbow in at least one direction (e.g., horizontally level the lateral axis of the crossbow barrel 121). Then, with at least the lateral axis of the crossbow barrel 121 horizontally level, the second level device 210 (or secondary leveling device) is utilized to level the crossbow scope 140 so that the scope reticle is in a non-canted orientation with respect to the vertical and lateral axes of the crossbow barrel 121, before securely tightening down the crossbow scope via scope rings. As explained below, the crossbow scope leveling system (e.g., leveling kit) allows an individual to rotate the crossbow scope, as needed, to adjust the scope reticle from a canted orientation to a non-canted orientation with respect to the vertical and lateral axes of the crossbow barrel 121, before securely tightening down the crossbow scope via scope rings.

Referring to FIG. 2A, the first level device 200 comprises a baseplate 201, a vertical post 202, a level support element 203, a bubble level 204, a bowstring groove 205 formed in an upper surface of the baseplate 201, and a tongue structure 206 disposed on a bottom surface of the baseplate 201. In some embodiments, as shown in FIG. 2A, the bubble level 204 comprises a tubular bubble level which is fixedly secured to the level support element 203 via, e.g., glue or epoxy. The first level device 200 (or primary leveling device) is utilized to horizontally level the crossbow 100, e.g., horizontally level the lateral axis of the crossbow barrel 121. As explained in further detail below, the first level device 200 is configured to be temporarily installed on the upper surface (flight rail 122) of the crossbow barrel 121 with the tongue structure 206 disposed within the flight groove 122g, and the bowstring 115 disposed within the bowstring groove 205. With this exemplary configuration, the first level device 200 is securely held in place with the bottom surface of the baseplate 201 in planar contact with the upper surface (flight rail 122) of the crossbow barrel 121, while the tongue structure 206 disposed within the flight groove 122g and the bowstring 115 disposed within the bowstring groove 205 collectively serve to fixedly secure the first level device 200 in position on the upper surface (flight rail 122) of the crossbow barrel 121.

Next, FIGS. 2B, 2C, 2D, and 2E illustrate different views of the second level device 210. In particular, FIG. 2B illustrates a top perspective view of the second level device 210, FIG. 2C illustrates a top plan view of the second level device 210, FIG. 2D illustrates a bottom perspective view of the second level device 210, and FIG. 2E illustrates a side view of the second level device 210. The second level device 210 comprises a level support element 211 (or level housing 211), first and second retaining walls 212 and 213, an alignment element 214, and a bubble level 215. In some embodiments, the bubble level 215 comprises a tubular bubble level. The level housing 211 comprises a recess 211R (or groove) formed in an upper surface thereof. The recess 211R is configured to insertably receive a least a portion of the bubble level 215, wherein the bubble level 215 is fixedly secured within the recess 211R of the level housing 211 via, e.g., glue or epoxy.

The first and second retaining walls 212 and 213 protrude from a bottom surface 211B of the level housing 211. The bottom surface 211B of the level housing 211 is flat and planar. In some embodiments, the first and second retaining walls 212 and 213 are curved-shaped elements. For example, in some embodiments, the first and second retaining walls 212 and 213 are arc-shaped elements which define segments of a circumference of a circle having a diameter, denoted D, as shown in FIGS. 2D and 2E. For example, in some embodiments, the diameter D is slightly larger than a diameter of the scope adjustment turret (e.g., the elevation turret 143). The alignment element 214 comprises an elongated element which is disposed on one side of the housing element 211, and which extends in direction that is orthogonal to a longitudinal axis of the tubular bubble level element 215.

As noted above, the second level device 210 (or secondary leveling device) is utilized to level the crossbow scope 140 to ensure that the scope reticle is in a non-canted orientation, before securely tightening down the crossbow scope 140 via the scope rings 145. In particular, the second level device 210 is utilized to level the crossbow scope 140 (e.g., place the scope reticle 148 in non-canted orientation) after horizontally leveling at least the lateral axis of the crossbow barrel 121 using the using the first level device 200. For example, the second level device 210 is placed on top of the elevation turret 143 with (i) an upper portion of the circular-shaped elevation turret 143 disposed between the first and second retaining walls 212 and 213, (ii) the flat (planar) bottom surface 211B of the housing 211 resting on top of elevation turret 143 (with or without the turret cap 143C), and with (iii) the alignment element 214 aligned in the same direction (e.g., X-direction) as the longitudinal axis of the crossbow barrel 121.

With this exemplary leveling process, with the scope rings 145 loosened, the crossbow scope 140 can be rotated in either the clockwise direction or the counterclockwise direction, as needed, until the bubble level 215 indicates a level position. When the first and second level devices 200 and 210 are both reading level (e.g., same level indication), this ensures that the vertical alignment line of the scope reticle (e.g., vertical line L1 of the scope reticle 148, FIG. 1D) is aligned with the vertical axis of the crossbow barrel 121 which, in turn, ensures that the scope reticle is properly orientated in a non-canted orientation with respect to the vertical and lateral axes of the crossbow barrel 121. As the crossbow scope 140 is rotated, the second level device 210 is held in place with the first and second retaining walls 212 and 213 disposed adjacent to sidewall portions of the elevation turret 143, which prevents the second level device 210 from slipping off the elevation turret 143 of the crossbow scope 140. Once the crossbow scope 140 is rotated to the desired position, the crossbow scope 140 can be secured in position by tightening the scope rings 145. It is to be noted that while FIG. 2D illustrates an exemplary embodiment where the first and second retaining walls 212 and 213 are curve-shaped elements, in other embodiments, the second level device 210 can have any suitable structural configuration of retaining walls that extend from the bottom surface 211B of the housing element 211 which serve to prevent the second level device 210 from slipping off the elevation turret 143 of the crossbow scope 140 as the crossbow scope 140 is rotated.

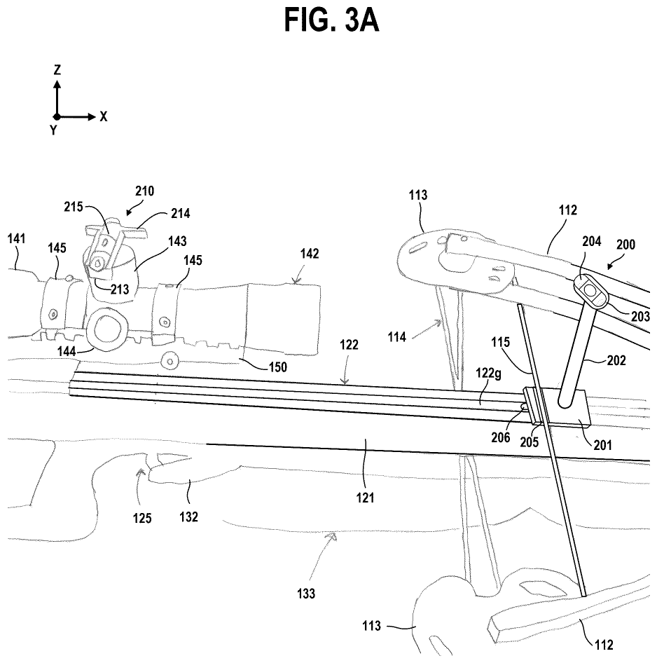

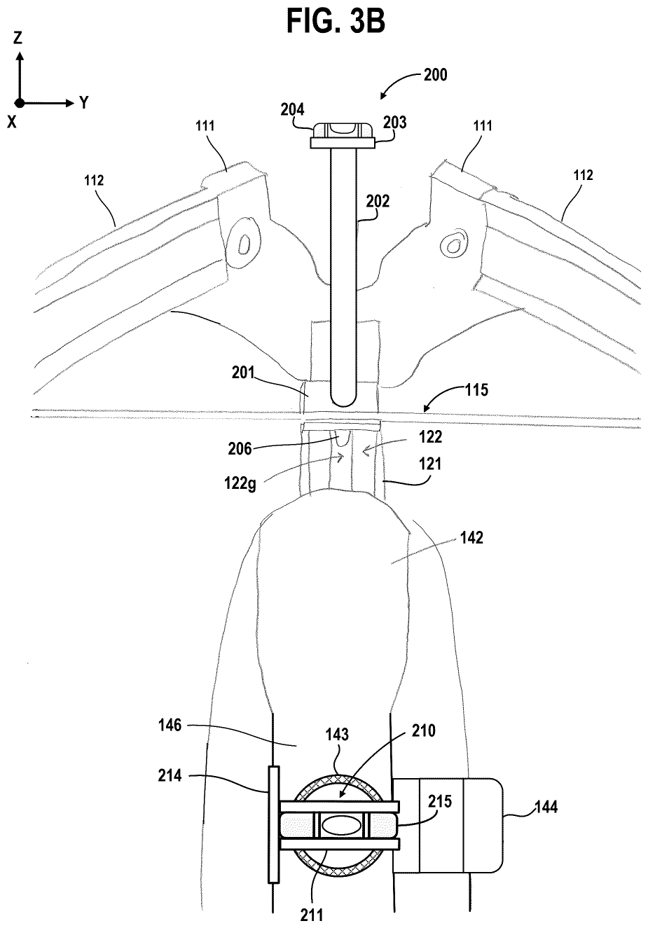

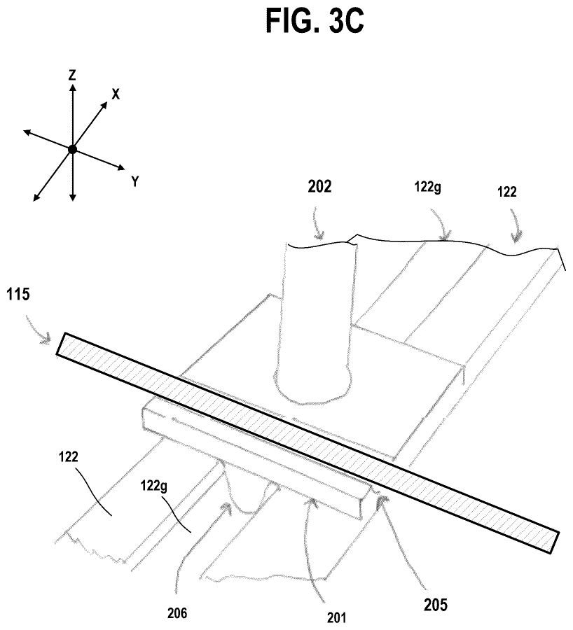

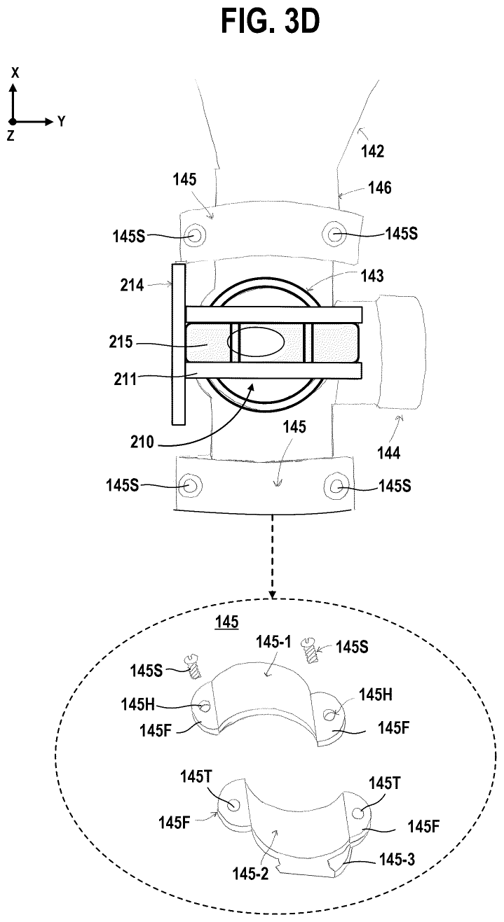

FIGS. 3A, 3B, 3C, and 3D schematically illustrate a method for utilizing a leveling system (e.g., leveling kit) comprising first and second level devices to bore sight a crossbow scope, according to exemplary embodiments of the disclosure. In particular, FIGS. 3A-3D schematically illustrate a method for utilizing the leveling system (e.g., leveling kit) comprising the first and second level devices 200 and 210 as discussed above to bore sight the crossbow scope 140, e.g., align the scope reticle in a non-canted orientation with respect to the vertical and lateral axes of the crossbow barrel 121. As an initial phase of the bore sighting process, FIGS. 3A, 3B, and 3C schematically illustrate a method to temporarily install the first level device 200 on the upper surface (flight rail 122) of the crossbow barrel 121 with (i) the bottom surface of the baseplate 201 in planar contact with the upper surface (flight rail 122) of the crossbow barrel 121, (ii) the tongue structure 206 on the bottom surface of the baseplate 201 disposed within the flight groove 122g of the crossbow barrel 121, and (iii) the bowstring 115 disposed within the bowstring groove 205 in the upper surface of the baseplate 201. In this configuration, the first level device 200 is held in place by virtue of the bowstring 115 (in the bowstring groove 205) applying downward pressure against the baseplate 210, and the tongue structure 206 being disposed within the flight groove 122g of the crossbow barrel 121.

With the first level device 200 installed and disposed on the upper surface (flight rail 122) of the crossbow barrel 121, the crossbow 100 is manipulated to obtain a level reading/indication by the bubble level 204 of the first level device 200, which indicates that the lateral axis of the crossbow barrel 121 is horizontally level. Once the level reading is obtained using the first level device 200, the crossbow 100 can be fixedly secured in place using any suitable crossbow vise system or stable rest system. It is to be noted that the proper alignment (non-canted orientation) of the scope reticle can be obtained using the first and second level devices 200 and 210, with the lateral axis of the crossbow barrel 121 in a horizontally level (non-tilted) orientation, even if the longitudinal axis of the crossbow barrel 121 is not horizontally level (e.g., slightly tilted) in the shooting direction. In this regard, in the context of the exemplary crossbow scope leveling methods described herein, the crossbow 100 is deemed to be “partially level” when at least the lateral axis of the crossbow barrel 121 is horizontally level (non-tilted), while the longitudinal axis of the crossbow barrel 121 is tilted (e.g., slightly pitched downward or upward).

In a next phase of the scope leveling process, FIGS. 3A, 3B, and 3D schematically illustrate a method to temporarily install the second level device 210 on the upper scope adjustment dial (the elevation turret 143) of the crossbow scope 140 with (i) the upper portion of the circular-shaped elevation turret 143 disposed between the first and second retaining walls 212 and 213, (ii) the flat (planar) bottom surface 211B of the housing 211 resting on top of elevation turret 143 (with or without the turret cap 143C), and with (iii) the alignment element 214 aligned in a direction parallel to the longitudinal axis of the crossbow barrel 121. In this configuration, with the bubble level 204 of the first level device 200 indicating that the lateral axis of the crossbow barrel 121 is horizontally level (non-tilted), the scope reticle of the crossbow scope 140 will be in non-canted position when the bubble level 215 of the second level device 210 is also showing a level indication.

For example, FIGS. 3A and 3B schematically illustrate a desired state of levelness (dual state of levelness) which is achieved when the bubble levels 204 and 215 of the respective first and second level devices 200 and 210 both indicate a level state. In this dual state of levelness, the level indication (centered bubble) of the bubble level 204 of the first level device 200 indicates that the lateral axis of the crossbow barrel 121 is horizontally level, and the level indication (centered bubble) of the bubble level 215 of the second level device 210 indicates that the crossbow scope 140 is properly aligned (in a non-canted angular rotation) with the vertical and horizontal lines of the scope reticle 148 aligned in a non-canted orientation with respect to the vertical and lateral axes of the crossbow barrel 121.

On the other hand, assuming the bubble level 204 of the first level device 200 indicates that the lateral axis of the crossbow barrel 121 is horizontally level (non-tilted), FIG. 3D illustrates an exemplary unlevel state (off-centered bubble) of the bubble level 215 of the second level device 210, which indicates that the crossbow scope 140 is not properly aligned (improper angular rotation), whereby the vertical and horizontal lines of the scope reticle 148 would be disposed in a canted orientation with respect to the vertical and lateral axes of the crossbow barrel 121. In particular, with the second level device 210 disposed on the upper scope adjustment dial (the elevation turret 143) of the crossbow scope 140, FIG. 3D illustrates an exemplary state of unlevelness where the bubble level 215 of the second level device 210 indicates (via the off-centered bubble which is positioned left of center) that the crossbow scope 140 is improperly positioned in a clockwise rotation, whereby the vertical and horizonal lines (e.g., L1 and L2) of the scope reticle 148 would have an angular deviation from vertical axis and the lateral axis of the crossbow barrel 121 (such as depicted in FIG. 1D by the scope reticle 148 on the right). In this instance, if not already loose, an individual would loosen the scope rings 145, and then slightly rotate the crossbow scope 140 in a counterclockwise direction until the bubble level 215 of the second level device 210 shows a centered bubble, in which case the crossbow scope 140 would be at the proper angular orientation with the scope reticle 148 being positioned in a non-canted orientation with respect to the vertical and lateral axes of the crossbow barrel 121. The individual would then tighten the scope rings 145 to fixedly secure the crossbow scope 140 is the proper angular orientation.

FIG. 3D illustrates an exploded view of a given scope ring 145 which comprises an upper scope ring 145-1 and a scope ring base 145-2. The scope ring base 145-2 comprises a coupling element 145-3 which is configured to interface with and connect to a given scope mount rail (e.g., scope mount rail 150, FIGS. 1A and 3A). The upper scope ring 145-1 and the scope ring base 45-2 are designed to clamp around the scope body 146 (or scope tube) of the crossbow scope 140, ensuring that the crossbow scope 140 remains fixedly secured in place during use of the crossbow 100. As shown in FIG. 3D, the upper scope ring 145-1 and the scope ring base 145-2 have respective flanges 145F. The flanges 145F of the upper scope ring 145-1 have through holes 145H which insertably receive screws 145S, and the flanges 145F of the scope ring base 145-2 have threaded holes 145T. The upper scope ring 145-1 is attached to the scope ring base 145-2 by inserting the screws 145S through the holes 145H of the upper scope ring 145-1, and screwing the screws 145S into the threaded holes 145T of the scope ring base 145-2 to clamp the upper scope ring 145-1 down against the scope body 146 of the crossbow scope 140. When the angular rotation of the crossbow scope 140 needs to be adjusted, the upper scope ring 145-1 can be loosened by slightly unscrewing the screws 145S to allow an individual to rotate the crossbow scope 140 in either a clockwise direction or a counterclockwise direction, as needed, until the bubble level 215 of the second level device 210 indicates a level position.

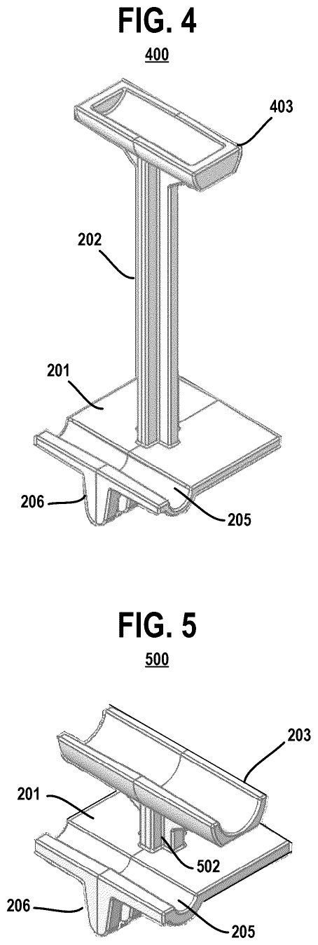

FIG. 4 is a schematic perspective view of a level device which is configured for use in bore sighting a crossbow scope, according to another exemplary embodiment of the disclosure. In particular, FIG. 4 schematically illustrates a level device 400 (primary level device) which is similar to the level device 200 of FIG. 2A in that the level device 400 comprises the baseplate 201, the vertical post 202, the bowstring groove 205 formed in an upper surface of the baseplate 201, and the tongue structure 206 disposed on a bottom surface of the baseplate 201, which perform the same functions as described above. However, the level device 400 comprises a level support element 403 which differs from the level support level element 203 (FIG. 2A) in that the level support element 403 comprises additional sidewalls at the ends thereof, which provide additional surface contact area to fixedly secure via, e.g., glue or epoxy, end portions of a tubular bubble level to the level support element 403.

Next, FIG. 5 is a schematic perspective view of a level device which is configured for use in bore sighting a crossbow scope, according to another exemplary embodiment of the disclosure. In particular, FIG. 5 schematically illustrates a level device 500 (primary level device) which is similar to the level device 200 of FIG. 2A in that the level device 400 comprises the baseplate 201, level support level element 203, the level the bowstring groove 205 formed in an upper surface of the baseplate 201, and the tongue structure 206 disposed on a bottom surface of the baseplate 201, which perform the same functions as discussed above. However, the level device 500 comprises a vertical post 502 which is shorter than the vertical post 202 (FIG. 2A). It is to be noted that in other embodiments, a primary level device can be designed with no post (e.g., eliminate post 202 or post 502) where the level support element 203 or 403 is disposed on the upper surface of the baseplate 201.

The elongated post 202 of the level devices 200 and 400 serves to maintain the bubble levels of the first and second level devices (e.g., bubble levels 204 and 215 of the first and second level devices 200 and 210) at essentially the same or similar height relative to the upper surface (flight rail 122) of the crossbow barrel 121 (such as shown in FIGS. 3A and 3B), which facilitates in-line viewing of both bubble levels by an individual when checking and adjusting the angular orientation of the crossbow scope 140. However, such in-line viewing is not necessary, and eliminating (or shortening) the vertical post 202 minimizes the chance of potential warping or bending (at time of manufacture, or subsequent to manufacture) of the vertical post 202, which would degrade the accuracy of the level device.

The exemplary primary level devices 200, 400 and 500 as shown in FIGS. 2A, 4, and 5 are configured to horizontally level the lateral axis of the crossbow barrel 121 to achieve at least a “partially level” orientation of the crossbow 100 which, as noted above, is sufficient to allows the scope reticle 148 of the crossbow scope to be adjusted to a non-canted orientation with respect to the vertical and lateral axes of the crossbow barrel 121. However, there can be instances where an individual would prefer the crossbow 100 to be placed in a “completely level” orientation where both the longitudinal axis and the lateral axis of the crossbow barrel 121 are horizontally level, when performing tuning and adjustment operations such as bore sighting or otherwise. In this regard, exemplary embodiments of the disclosure further include primary level devices which are configured for use to place the crossbow barrel 121 in a “completely level” orientation when bore sighting a crossbow scope.

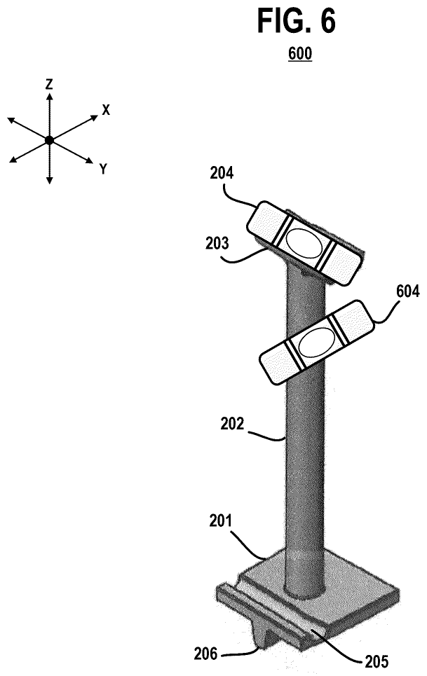

For example, FIG. 6 is a schematic perspective view of a level device which is configured for use in bore sighting a crossbow scope, according to another exemplary embodiment of the disclosure. In particular, FIG. 6 schematically illustrates a level device 600 (primary level device) which is configured for use in placing the crossbow barrel 121 in a completely level orientation. The level device 600 is similar to the level device 200 of FIG. 2A, except that the level device 600 comprises an additional bubble level 604 which is disposed orthogonal to the bubble level 204 and oriented in the direction of the longitudinal axis of the crossbow barrel 121. The bubble level 204 is utilized to horizontally level the lateral axis of the crossbow barrel 121 as discussed above, and the additional bubble level 604 is utilized to horizontally level the longitudinal axis of the crossbow barrel 121.

For ease of illustration, FIG. 6 shows the additional bubble level 604 connected to the vertical post 202 below the bubble level 204. However, the bubble levels 204 and 604 can be connected using any suitable connection means, as long as the bubble levels 204 and 604 are positioned orthogonal to each other and orientated/aligned with the lateral and longitudinal axes of the crossbow barrel 121 when the leveling device 600 is temporarily mounted on the upper surface (flight rail 122) of the crossbow barrel 121, to thereby enable an individual to level the crossbow 100 with both of the lateral and longitudinal axes of the crossbow barrel 121 in a horizontally level orientation.

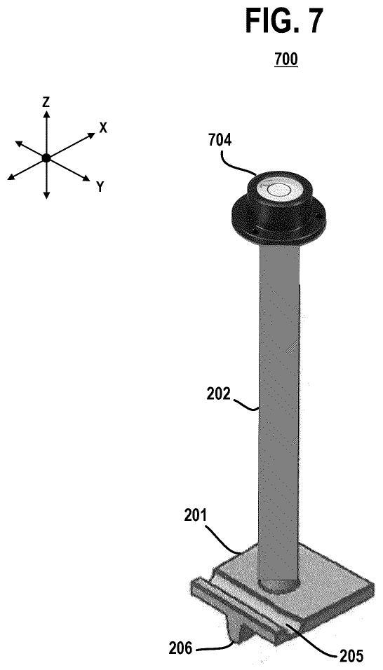

Next, FIG. 7 is a schematic perspective view of a level device which is configured for use in bore sighting a crossbow scope, according to another exemplary embodiment of the disclosure. In particular, FIG. 7 schematically illustrates a level device 700 (primary level device) which is configured for use in placing the crossbow barrel 121 in a completely level orientation. The level device 700 is similar to the level device 200 of FIG. 2A, except that the level device 700 comprises a circular bubble level 704 (in place of the tubular bubble level 204). The circular bubble level 704 (or bull's eye bubble level) comprises a circular bubble that is used to horizontally level the crossbow barrel 121 in two dimensions, i.e., horizontally level the lateral axis and horizontally level the longitudinal axis of the crossbow barrel 121.

The exemplary level devices 600 and 700 allow an individual to position the crossbow 100 in a “completely level” orientation where both the longitudinal axis and the lateral axis of the crossbow barrel 121 are horizontally level to perform tuning and adjustment operations. For example, with the crossbow 100 fixed in a “completely level” orientation, the individual can utilize the secondary level device 210 to adjust the angular orientation of the crossbow scope 140 and thereby place the scope reticle 148 in a non-canted orientation with respect to the vertical and lateral axes of the crossbow barrel 121, using techniques as described above. Moreover, with the crossbow 100 fixed in a “completely level” orientation, the individual can utilize the secondary level device 210 to check that the crossbow scope 140 is positioned parallel to the longitudinal axis of the crossbow barrel 121.

In particular, referring back to FIG. 3B, assuming the crossbow barrel 121 is in a completely level orientation, the individual can rotate the second level device 210 by 90 degrees where the elongated alignment element 214 is aligned in the direction of the lateral axis of the crossbow barrel 121. In this position, the second level device 210 can be used to check whether the longitudinal axis (or optical centerline) of the crossbow scope 140 is level and thus parallel to longitudinal axis of the crossbow barrel 121. If the longitudinal axis of the crossbow scope 140 is not level, then suitable adjustments can be made, if desired, to level the crossbow scope 140 in the X-axis direction. It is to be noted that while the exemplary secondary level device 210 (FIGS. 2B-2D) implements a tubular bubble level, in other embodiments, the secondary level device 210 can designed to implement a circular bubble level instead of a tubular bubble level.

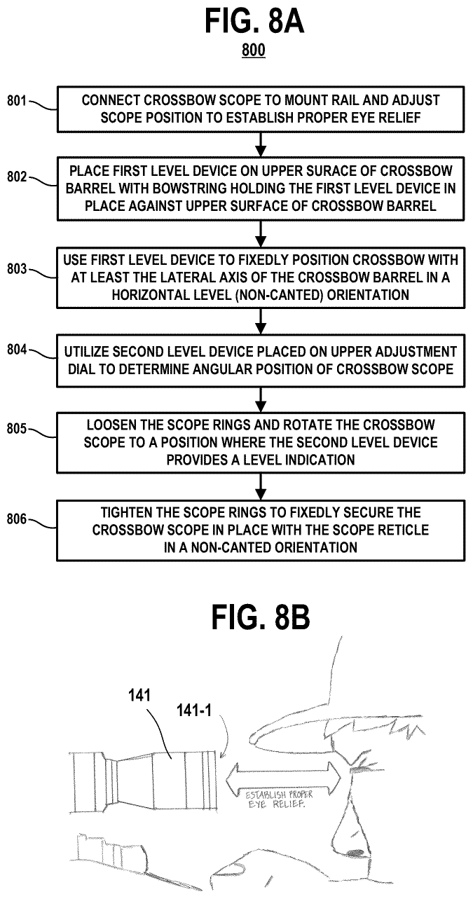

FIGS. 8A and 8B illustrate a method for bore sighting a crossbow scope using a leveling system comprising first and second level devices, according to exemplary embodiment of the disclosure. In particular, FIG. 8A illustrates a flow diagram of a method 800 for bore sighting a crossbow scope using a leveling system (or leveling kit) which comprises exemplary embodiments of the first and second level devices as described herein. As an initial step, an individual will connect a crossbow scope to a scope mount rail of the crossbow, and adjust the position of the crossbow scope to establish proper eye relief (block 801). For example, FIG. 8B schematically illustrates a process for establishing proper eye relief, which refers to the distance between the individual's eye and an ocular lens 141-1 of an eyepiece 141 of the crossbow scope 140. The proper eye relief is unique to the individual, as it depends on various factors including, but not limited to, the individual's vision, the given type of crossbow scope, the individual's preferred “cheek weld”, and other factors. The term “cheek weld” refers to the contact between the individual's cheek and the buttstock of the crossbow, which contact is crucial for maintaining a stable and consistent shooting posture and, thus, essential for shooting accuracy.

Typically, a crossbow scope comes with the scope rings already attached to the crossbow scope, whereby the individual would simply attach the crossbow scope to the mount rail by connecting the coupling elements of each scope ring base to a desired position on the given scope mount rail. As noted above, a given scope rail mount can be one of various types of scope rail configurations including, e.g., a Weaver rail, dovetail rail, a Picatinny rail, etc., where the scope base element would have coupling elements that match with the mechanical mating interfaces of scope rail mount. When a crossbow scope comes with the scope rings already attached thereto, the manufacture may indicate the crossbow scope is “pre-sighted” in that angular orientation of the crossbow scope is properly set to provide a non-canted reticle when the individual simply connects the scope ring base elements to the given scope rail mount. However, this is not always the case, and the exemplary scope leveling methods described herein allow an individual to determine whether or not the “pre-sighted” configuration of the crossbow scope actually provides the proper scope reticle alignment.

After the desired eye relief is achieved, the individual will place the first (primary) level device on the upper surface (flight rail) of the crossbow barrel with the bowstring inserted in the bowstring groove to hold the first level device in place on top of the crossbow barrel (block 802). The first level device can be any one of the exemplary embodiments of the primary level devices 200, 400, 500, 600 or 700 as described above, depending on whether the individual wants to (i) at least partially level the crossbow (e.g., using primary level devices 200, 400, or 500) or to (ii) completely level the crossbow (e.g., using primary level device 600 or 700).

With the first (primary) level device installed and disposed on the upper surface of the crossbow barrel, the individual will utilize the first level device to fixedly position the crossbow in at least a partially level position where at least the lateral axis of the crossbow barrel is horizontally level (block 803). In particular, the individual will manipulate and position the crossbow in a way to obtain a level reading/indication by the bubble level of the first level, which indicates that the lateral axis of the crossbow barrel is horizontally level. Once the level reading is obtained using the first level device, the crossbow can be fixedly secured in place using any suitable crossbow vise system or stable rest system. Alternatively, the individual can utilize a given primary level device (e.g., level device 600 or level device 700) which is configured to fixedly position the crossbow in a completely level position where both the lateral axis and the longitudinal axis of the crossbow barrel are horizontally level.

Next, with the first level device indicating that crossbow barrel is partially level (lateral axis of crossbow barrel is horizontally level) or completely level (longitudinal and lateral axes of crossbow barrel are horizontally level), the individual will utilize the second level device, which is placed on the upper scope adjustment dial (e.g., elevation turret) of the crossbow scope, to determine the angular position of the crossbow scope (block 804). In particular, as noted above the second level device (when placed on the upper scope adjustment dial of the crossbow scope) is utilized to determine whether or not the crossbow scope is improperly rotated in a clockwise or counterclockwise position where the scope reticle would be in a canted orientation with respect to the vertical and lateral axes of the crossbow barrel.

When the bubble level of the second level device provides a level reading/indication, the scope reticle of the crossbow scope will be deemed to be in a non-canted orientation with respect to the vertical and lateral axes of the crossbow barrel. On the other hand, when the bubble level of the second level device provides a unlevel reading/indication, the scope reticle of the crossbow scope will be deemed to be in a canted orientation with respect to the vertical and lateral axes of the crossbow barrel. In this case, the crossbow scope could be slightly rotated clockwise or counterclockwise from the desired non-canted angular orientation. In this instance, the individual can loosen the scope rings (as discussed above in conjunction with FIG. 3D) and rotate the crossbow scope either clockwise or counterclockwise, as needed, to obtain a level reading/indication by the bubble level of the second level device (block 805).

When a level reading by the second level device is obtained, the individual will proceed to tighten the scope rings to fixedly secure the crossbow scope in place with the scope reticle in the non-canted orientation (block 806). While tightening the scope rings, the individual can view the bubble levels of the first and second level devices to make sure that the bubble levels maintain level readings while the scope rings are being tightened.

It is to be noted that the exemplary level devices described herein can be utilized in conjunction with other techniques for bore sighting or otherwise leveling crossbow scopes. By way of example, any one of the first (primary) level devices 200, 400, 500, 600 or 700 as described above can be utilized in conjunction with a plumb bob line for sighting a crossbow scope. In particular, one of the first (primary) level devices 200, 400, 500, 600 or 700 can be utilized to partially level or completely level a crossbow with the crossbow scope mounted thereon. A plumb bob line can be hung at some distance from the crossbow scope in alignment with the plumb bob line. In an exemplary embodiment, the plumb bob line can first be hung to provide a reference line, and the crossbow can be secured in a vise, where the crossbow is leveled (partially or completely) with the crossbow scope pointing in alignment to the plumb bob line (as viewed by an individual through the crossbow scope). Thereafter, the individual can rotate the crossbow scope, as needed, so that a vertical line of the scope reticle is aligned to, or otherwise parallel with, the reference line provided by the plumb bob line. With this process, the first (primary) level devices 200, 400, 500, 600 or 700 can be utilized in conjunction with the plumb bob line, without the need to use the secondary level device 210 to adjust the scope reticle to a non-canted orientation. However, as noted above, secondary level device 210 can be utilized to check whether the longitudinal axis (or optical center line) of the crossbow scope is aligned parallel to the longitudinal axis of the crossbow barrel.

It is to be noted that in some embodiments, the exemplary level devices described herein are fabricated as single integrated components that are made of any suitable materials such as plastics or composite materials, and manufactured using suitable techniques including, but not limited to, as injection molding, compression molding, CNC machining, etc. The bubble level devices can be separately manufactured and the connected to corresponding mounting surfaces or mounting elements of the level devices via, glue, epoxy, or other connection means.

Although exemplary embodiments have been described herein with reference to the accompanying figures, it is to be understood that the current disclosure is not limited to those precise embodiments, and that various other changes and modifications may be made therein by one skilled in the art without departing from the scope of the appended claims.

What is claimed is:

1. A level device, comprising:
a baseplate having an upper surface and a bottom surface, and comprising a groove formed in the upper surface, and a tongue structure disposed on the bottom surface; and
a bubble level coupled to the upper surface of the baseplate;
wherein the level device is structurally configured for mounting on an upper surface of a crossbow barrel of a crossbow, with the bottom surface of the baseplate in contact with the upper surface of the crossbow barrel and the tongue structure disposed within a flight groove of the crossbow barrel, and a portion of a bowstring of the crossbow disposed within the groove in the upper surface of the baseplate to secure the level device on the upper surface of the crossbow barrel.

2. The level device of claim 1, wherein the bubble level comprises a tubular bubble level which is disposed in alignment with a lateral axis of the crossbow barrel, when the level device is mounted on the upper surface of the crossbow barrel.

3. The level device of claim 2, further comprising another tubular bubble level which is disposed in alignment with a longitudinal axis of the crossbow barrel, when the level device is mounted on the upper surface of the crossbow barrel.

4. The level device of claim 1, wherein the bubble level comprises a circular bubble level.

5. The level device of claim 1, further comprising a vertical post, wherein one end of the vertical post is coupled to the upper surface of the baseplate, and wherein another end is coupled to the bubble level.

6. The level device of claim 1, wherein the level device is configured for use in horizontally leveling a lateral axis of the crossbow barrel, when the level device is mounted on the upper surface of the crossbow barrel.

7. The level device of claim 1, wherein the level device is configured for use in horizontally leveling both a lateral axis of the crossbow barrel and a longitudinal axis of the crossbow barrel, when the level device is mounted on the upper surface of the crossbow barrel.

8. A level device, comprising:
a housing element configured to house a bubble level;
a first retaining wall and a second retaining wall, which extend from a planar bottom surface of the housing element, and spaced apart by a given distance; and
an elongated alignment element extending from the housing element;
wherein the level device is structurally configured for mounting on an upper scope adjustment dial of a crossbow scope, with the planar bottom surface of the housing element in contact with a top surface of the upper scope adjustment dial, and the upper scope adjustment dial disposed between the first and second retaining walls.

9. The level device of claim 8, wherein the bubble level comprises a tubular bubble level.

10. The level device of claim 9, wherein a longitudinal axis of the elongated alignment element is disposed orthogonal to a longitudinal axis of the tubular bubble level.

11. The level device of claim 8, wherein:
the housing element comprises a recess in an upper surface of the housing element; and
the bubble level is disposed within the recess with an upper portion of the bubble level exposed above the upper surface of the housing element.

12. The level device of claim 8, wherein the first retaining wall and the second retaining wall each comprise a curved wall structure.

13. The level device of claim 12, wherein:
the curved wall structures of the first and second retaining walls comprise arc-shaped elements which define segments of a circumference of a circle having a given diameter; and
the given diameter is larger than a diameter of the upper scope adjustment dial.

14. The level device of claim 8, wherein the level device is configured for use in aligning a scope reticle of the crossbow scope in a non-canted orientation with respect to a longitudinal axis and vertical axis of a crossbow barrel of a crossbow, when the level device is mounted on the upper scope adjustment dial of the crossbow scope.

15. A leveling kit for bore sighting a crossbow scope, the leveling kit comprising:
a first level device which is structurally configured for mounting on an upper surface of a crossbow barrel of a crossbow, wherein the first level device is configured for use in horizontally leveling a lateral axis of the crossbow barrel, when the first level device is mounted on the upper surface of the crossbow barrel; and
a second level device which is structurally configured for mounting on an upper scope adjustment dial of a crossbow scope, wherein the second level device is configured for use in aligning a scope reticle of the crossbow scope in a non-canted orientation with respect to the lateral axis and a vertical axis of the crossbow barrel, when the second level device is mounted on the upper scope adjustment dial of the crossbow scope, and when the lateral axis of the crossbow barrel is horizontally leveled by use of the first level device mounted on the upper surface of the crossbow barrel.

16. The leveling kit of claim 15, wherein the first level device comprises:
a baseplate having an upper surface and a bottom surface, and comprising a groove formed in the upper surface, and a tongue structure disposed on the bottom surface; and
a bubble level coupled to the upper surface of the baseplate;
wherein the first level device is structurally configured for mounting on the upper surface of the crossbow barrel with the bottom surface of the baseplate in contact with the upper surface of the crossbow barrel and the tongue structure disposed within a flight groove of the crossbow barrel, and a portion of a bowstring of the crossbow disposed within the groove in the upper surface of the baseplate to secure the first level device on the upper surface of the crossbow barrel.

17. The leveling kit of claim 16, wherein the bubble level of the first level device comprises a tubular bubble level which is disposed in alignment with the lateral axis of the crossbow barrel, when the first level device is mounted on the upper surface of the crossbow barrel.

18. The leveling kit of claim 15, wherein the second level device comprises:
a housing element configured to house a bubble level;
a first retaining wall and a second retaining wall, which extend from a planar bottom surface of the housing element, and spaced apart by a given distance; and
an elongated alignment element extending from the housing element;
wherein the second level device is structurally configured for mounting on the upper scope adjustment dial of the crossbow scope, with the planar bottom surface of the housing element in contact with a top surface of the upper scope adjustment dial, and the upper scope adjustment dial disposed between the first and second retaining walls.

19. The leveling kit of claim 18, wherein the bubble level of the second level device comprises a tubular bubble level.

20. The leveling kit of claim 19, wherein a longitudinal axis of the elongated alignment element is disposed orthogonal to a longitudinal axis of the tubular bubble level of the second level device.
